(19) United States
(12) Patent Application Publication
(10) Pub. No.: US 2018/0331384 A1
(43) Pub. Date: Nov. 15, 2018

(54) INSULATION AND COMPRESSION OF A HIGH TEMPERATURE DEVICE

(71) Applicant: SAINT-GOBAIN CERAMICS & PLASTICS, INC., Worcester, MA (US)

(72) Inventors: Brian P. FELDMAN, Northborough, MA (US); Yuto TAKAGI, Cambridge, MA (US); John D. PIETRAS, Sutton, MA (US)

(73) Assignee: SAINT-GOBAIN CERAMICS & PLASTICS, INC., Worcester, MA (US)

(21) Appl. No.: 15/775,782

(22) PCT Filed: Nov. 11, 2016
(86) PCT No.: PCT/US16/61658

§ 371 Date: May 11, 2018

Related U.S. Application Data
(60) Provisional application No. 62/255,318, filed on Nov. 13, 2015.

(51) Int. Cl. H01M 8/248; H01M 8/2425; H01M 8/2475; H01M 2/10; H01M 10/39; H01M 10/658

(52) U.S. Cl. CPC H01M 8/248; H01M 8/2425; H01M 8/2475; H01M 2008/1293; H01M 10/39; H01M 10/658; H01M 2/1088

(57) ABSTRACT

A high temperature system can include a high temperature device having a plurality of opposite surfaces and a compression device that exerts a biaxial compression against the opposite surfaces. The high temperature system can include a high temperature insulation disposed between the compression device and the high temperature device, and a low temperature insulation disposed external to the compression device such that the compression device is disposed between the high temperature insulation and the low temperature insulation.

### TECHNICAL FIELD

The present disclosure relates to systems and methods of insulating and compressing high temperature devices.

Current solutions for insulating and compressing a high temperature device can be bulky and mechanically unsound. There exists a need for an improved system and method of insulating and compressing high temperature device.

### BRIEF DESCRIPTION OF THE DRAWINGS

Embodiments are illustrated by way of example and are not limited in the accompanying figures.

FIG. 1 includes an illustration of high temperature system according to embodiments described herein.

FIG. 2 includes an illustration of another high temperature system according to embodiments described herein.

FIG. 3 includes an illustration of another high temperature system according to embodiments described herein.

FIG. 4 includes an illustration of another high temperature system according to embodiments described herein.

FIG. 5 includes an illustration of another high temperature system according to embodiments described herein.

FIG. 6 includes a comparison between existing bulky configurations and more compact configurations according to embodiments described herein.

FIG. 7 includes an illustration of another high temperature system according to embodiments described herein.

FIG. 8 includes an illustration of a perspective view of another electrochemical system according to embodiments described herein.

FIG. 9 includes an illustration of a perspective view of another electrochemical system according to embodiments described herein.

FIG. 10 includes a graph plotting data showing inlet and outlet flow of air and fuel in an example of embodiments described herein.

FIG. 11 includes an illustration of another high temperature system according to embodiments described herein.

FIG. 12 includes an illustration of a high temperature system including a vertical-horizontal compression device according to embodiments described herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE PREFERRED EMBODIMENT(S)

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise.

For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the high temperature system arts.

High temperature devices, such as fuel reformers, heat exchangers, filters, reactors, electrochemical devices, and the like, can operate at temperatures of about 500° C. and up to 1000° C. or greater. Such high temperature devices may require compression, for example, to provide a seal, to maintain an electrical contact, or to maintain structural integrity. Some existing compression systems have used ceramic materials for various parts of a compression system, such as alumina or zirconia bolts and silicon nitride springs, specialty metals, or conventional metals with specialty coatings having high oxidation resistance and closely matched thermal expansion coefficients. Although ceramics and specialty metals can avoid corrosion and deformation under the extreme conditions, they can be brittle and fracture during high temperature compression. Other technologies have used a fully external compression system using stronger materials but require bulky insulation layers to reduce the temperature sufficiently to use those materials. However, the bulky insulation can increase the overall weight and size of the system, and in the case of electrochemical devices, can reduce volumetric power density and power-to-weight ratio (power/kg). As will be discussed in more detail below, certain embodiments of the systems disclosed herein have the advantage of allowing for using stronger, low temperature materials without reducing volumetric power density and power-to-weight ratio.

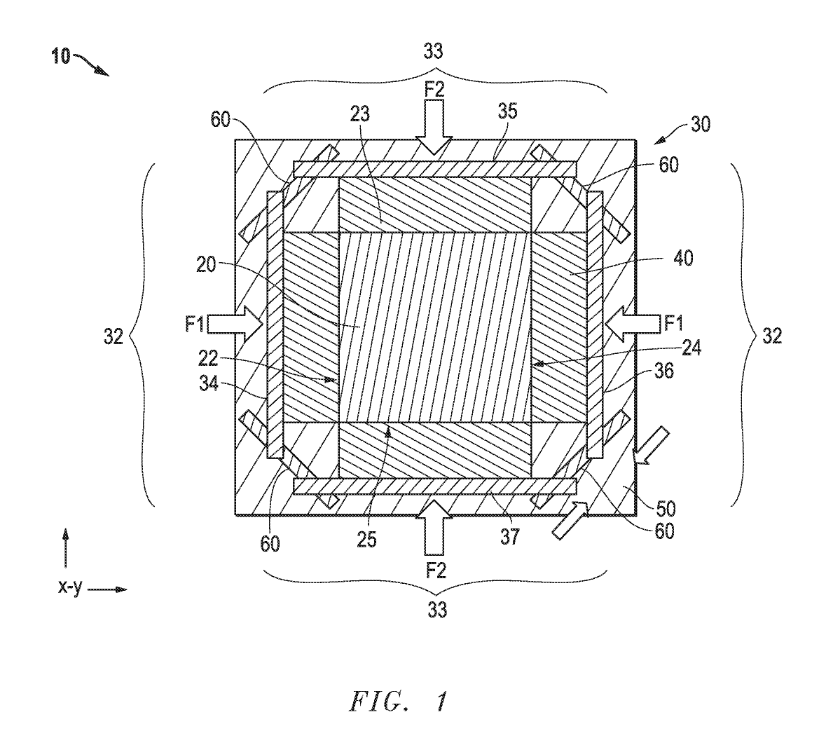

FIG. 1 includes an illustration of high temperature system 10 according to certain embodiments disclosed herein. As illustrated in FIG. 1, the high temperature system 10 can include a high temperature device 20. The high temperature device 20 can include a sidewall defining first plurality of opposite surfaces 22 and 24, and second plurality of opposite surfaces 23 and 25.

In certain embodiments, the high temperature device 20 can include a device having a maximum operating temperature of at least 500° C. In particular embodiments, the high temperature device 20 can have an operating temperature in a range of from about 500° C. to about 1000° C., or about 700° C. to about 900° C.

In particular embodiments, the high temperature device 20 can include a fuel reformer, a heat exchanger, a filter, a reactor, or an electrochemical device. In more particular embodiments, the high temperature device can include an electrochemical device, such as a battery or a fuel cell. In more particular embodiments, the electrochemical device can include a solid oxide fuel cell. In more particular embodiments, the electrochemical device can include a monolithic solid oxide fuel cell stack in which the directions of the air and gas flows are orthogonal to the direction of current flow and impinge on the exterior surfaces.

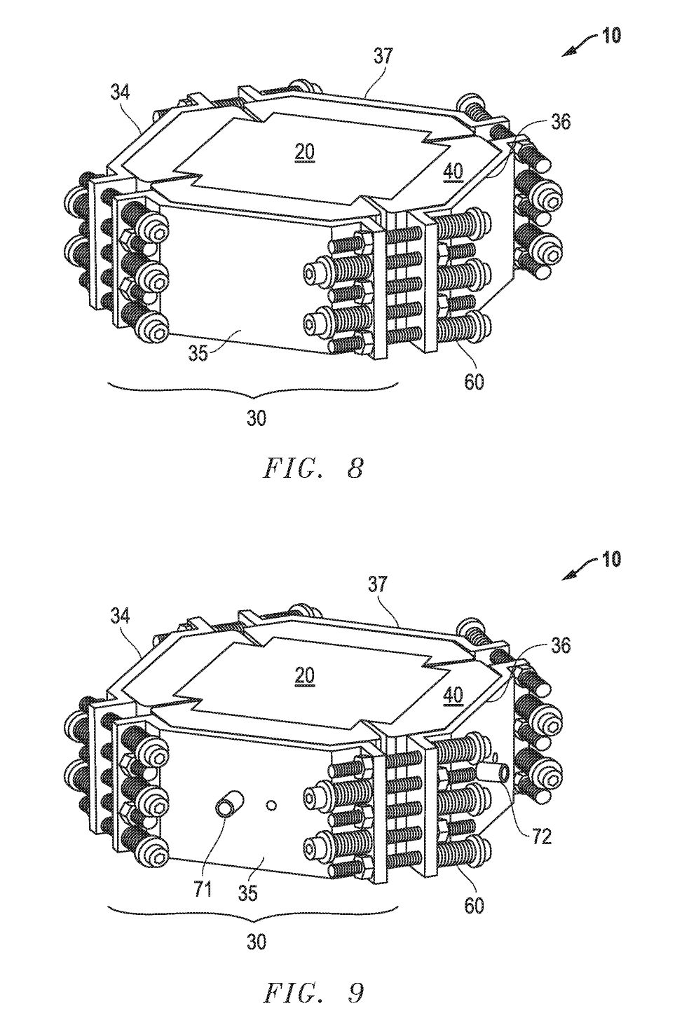

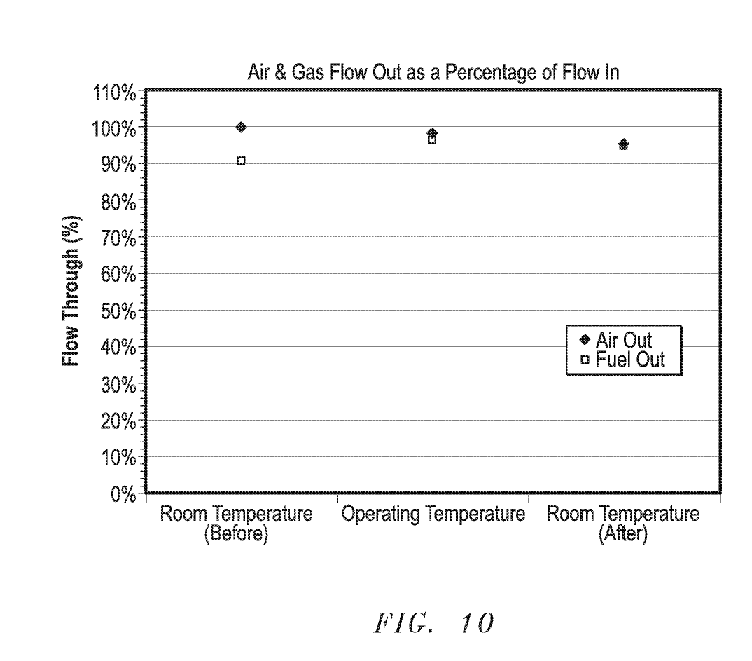

In certain embodiments (see, for example, FIG. 9), the high temperature device 20 can include a fluid inlet and a fluid outlet, which can be coupled to a fluid inlet conduit (not in view) and a fluid outlet conduit 71, 72 extending through the high temperature system 10. In particular embodiments, the fluid inlet conduit and the fluid outlet conduit comprise metal tubing. In further embodiments, the fluid inlet can include an air inlet and a fuel inlet, and the fluid outlet includes an air outlet and a fuel outlet.

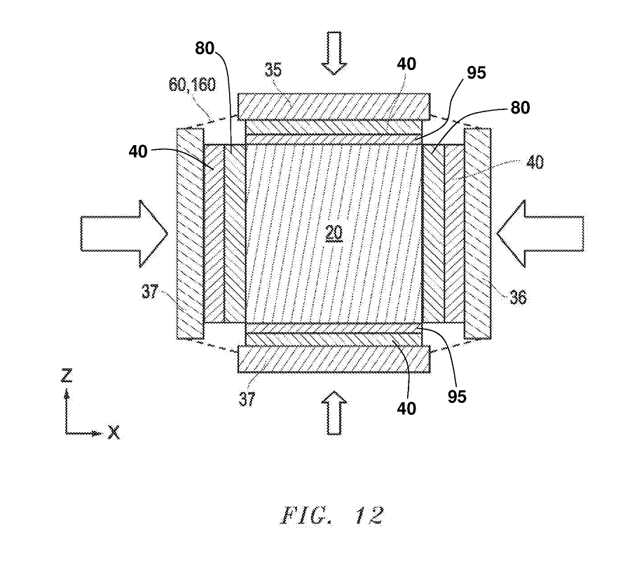

In certain embodiments, as illustrated in FIG. 11, the high temperature system can include a fluid delivery and distribution manifold 80 disposed adjacent the high temperature device 20. In particular embodiments, the fluid delivery and distribution manifold 80 can include a cross-flow fluid delivery and distribution manifold such that the fuel and air flow crosswise relative to each other through the high temperature device 20.

In further embodiments, the fluid delivery and distribution manifold can comprise a high temperature, non-yielding material, such as a material that maintains structural integrity at the operating temperature of the high temperature device. In particular embodiments, the high temperature, non-yielding material can include a ceramic. The ceramic can include, for example, an alumina, a stabilized zirconia, an MgO-doped MgAl₂O₄ spinel, or any combination thereof.

In further embodiments, the high temperature system 20 can include a seal 90 disposed between the fluid delivery and distribution manifold 80 and the high temperature device 20 such that the fluid delivery and distribution manifold 80 is separated from the high temperature device 20 by seal 90. In particular embodiments, the seal 90 can include a compressible gasket or a non-compressible gasket. The compressible gasket can include, for example, a phlogophite mica, a muscovite mica, a vermiculite, or any combination thereof. In particular embodiments, the vermiculite can include a chemically exfoliated vermiculite, such as a Thermiculite 866 or a Thermiculite 866 LS (available from Flexitallic, LP at Deer Park, Tex., USA). The non-compressible gasket can include, for example, a viscous glass, a glass ceramic, or a combination thereof. The seal 90 can be compressed against a surface of the high temperature device 20, for example, by the compression device 30, to maintain an essentially leak-free seal as fluid flows into or out of the high temperature device 20. Further, the seal 90 can be supported by compressing the seal against the high temperature device 20, for example, via the compression device 30, to prevent a leak-inducing creep.

It is recognized that any of the embodiments of the high temperature device, though not illustrated, can include a fluid delivery distribution 80, a seal 90, or both, as described above.

Referring again to FIG. 1, the high temperature system can include a compression device 30 external to the high temperature device 20. The compression device 30 can be adapted to provide multiaxial compression, such as biaxial compression, on the high temperature device 20. In certain embodiments, the biaxial compression can include a first compression force F1 along a first direction and, in particular embodiments, the first compression force F1 can be a uniaxial compression force along the first direction. In further embodiments, the biaxial compression can include a second compression force F2 in a second direction and, in particular embodiments, the second compression force F2 can be a uniaxial compression force in the second direction. In particular embodiments, the intersecting first and second directions can be orthogonal directions, as would be advantageous for high temperature devices such as solid oxide fuel cell stack with a cross-flow manifold. In an embodiment, the biaxial compression can be a vertical-horizontal compression, vertical compression refers to compression along the z axis and horizontal compression refers to compression along the x or y axis. Thus, vertical-horizontal compression refers to compression along the vertical axis and an orthogonal horizontal axis. In another embodiment, the biaxial compression can be a horizontal-horizontal compression, referring to compression along a first horizontal axis and a second orthogonal horizontal axis (e.g., x and y axes).

The biaxial compression can be used for a solid oxide fuel cell stack. A planar solid oxide fuel cell stack can include a planar geometry comprising a sandwich-type configuration where a series of electrolyte cells and interconnect plates are stacked in the vertical, z-axis direction from top to bottom. In such a configuration, the air and fuel can flow up and down the z-axis of the stack and requires compression between the top and bottom plates along the z-axis direction relative to the electrochemical device. In other configurations, the fuel and air flow could instead pass through the sides of the fuel cell along the x-y plane. Thus, in particular embodiments, horizontal-horizontal compression can be applied where the first direction F1 and the second direction F2 can lie along the x-y plane relative to the electrochemical device 20. In a more particular embodiment, the electrochemical device 20 can include a third plurality of opposite surfaces having an intersecting z-axis orthogonal to the first and second directions, and the compression device 30 does not or is not adapted to exert a compression force on the third plurality of opposite surfaces.

In other embodiments, the third plurality of opposite surfaces can function as the surface from which a current is collected, such as in the case of an electrochemical device, such as a fuel cell or battery. As will be discussed in more detail further below the compression device 30 can exert or be adapted to exert a compressive force on the third plurality of opposite surfaces and at least one of the first and second plurality of surfaces, using the vertical-horizontal compression. In an embodiment, force is applied on two of the pluralities of opposite surfaces, and in another embodiment, force is applied on each of the three pluralities of opposite surfaces.

The compression device 30 can include a spring compression device having a spring mechanism to assist in exerting the compression forces. In particular embodiments, the spring mechanism can comprise a first spring mechanism 32 and a second spring mechanism 33. The first spring mechanism 32 can be adapted to exert a first compression force F1 along a first direction intersecting the first opposite surfaces 22 and 24, and the second spring mechanism 33 can be adapted to exert a second compression force F2 along a second direction intersecting the second opposite surfaces 23 and 25.

In certain embodiments, the spring mechanisms can include spring elements 60 of the compression device 30, which can include compression springs, extension springs, or both. In particular embodiments, the spring elements 60 can include a bolt and spring assembly. In further embodiments, the springs 60 of the compression device can comprise a metal. In particular embodiments, the metal can include a nickel-iron alloy, a nickel-chromium alloy, or any combination thereof.

Further, the compression device 30 can include a load spreading device. The load spreading device can distribute the compressive force of the compression device onto, for example, the insulation, the manifold, or other components of the high temperature system. In an embodiment, the load spreading device can transfer the compressive force of the compression device onto the high temperature insulation such that stress on the high temperature insulation is less than its cold crush strength.

In an embodiment, the load spreading device can include a compression plate. For example, the compression device can include a first plurality of compression plates 34, 36 corresponding to the first plurality of opposite surfaces 22, 24 of the high temperature device, and can include a second plurality of compression plates 35, 37 corresponding to the second plurality of opposite surfaces 23, 25 of the high temperature device. In certain embodiments, the compression plates 34, 35, 36, 37 can be adapted to transmit and disperse load from a compressive source, such as the spring elements 60 discussed above, individually or interconnected, and provide the compression necessary for a gas seal, in the case of a fuel cell, or for current collection compression, in the case of a fuel cell or a battery. In further embodiments, the compression plates 34, 35, 36, 37 of the compression device 30 can comprise a metal. In particular embodiments, the metal can include a stainless steel alloy, a nickel-chromium alloy, or any combination thereof.

In further embodiments, the spring mechanisms can include at least one spring 60 disposed on opposite ends of each compression plate. To improve control over the compression levels, the spring elements 60 can include at least two, at least three, at least four, or at least five springs disposed on an end or on opposite ends of each compression plate. Springs have the advantage of compensating for a coefficient of thermal expansion mismatch, but in certain circumstances can be limited in the levels of force they can generate.

Different compression geometries are possible for an improved force generation depending on the desired application.

As illustrated in FIG. 1, each spring element 60 of the first and second spring mechanisms 32, 33 can activate one of the first opposite compression plates 34, 36 and one of the second opposite compression plates 35, 37. In certain embodiments, the spring elements 60 can extend in a longitudinal direction oblique to the first and second directions F1 and F2. Such a configuration can couple one of the first opposite compression plates 34, 36 to one of the second opposite compression plates 35, 37 and, in more particular embodiments, can distribute the compression forces substantially equally.

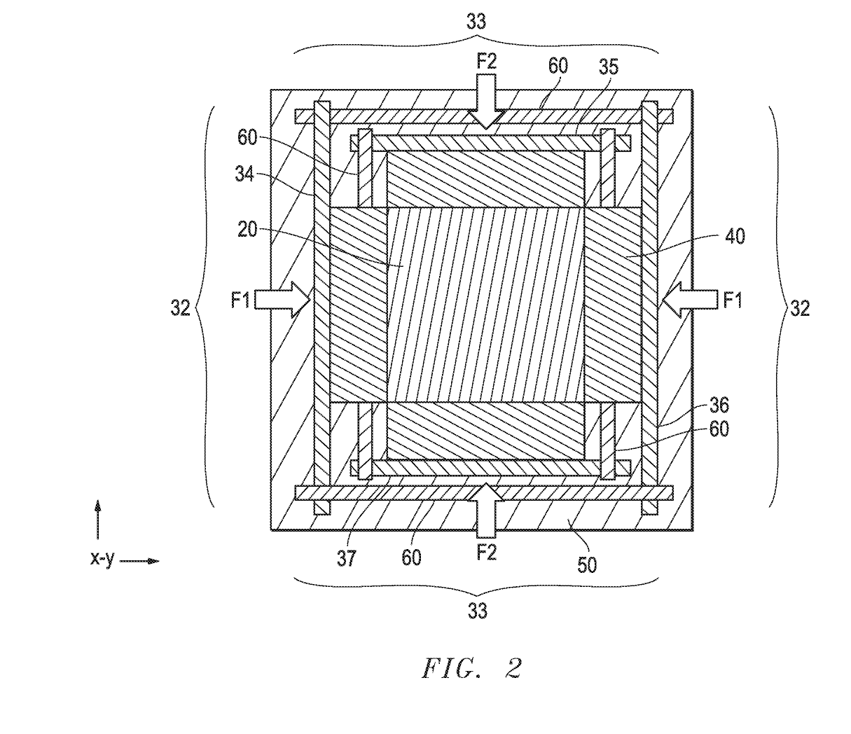

As illustrated in FIG. 2, each spring element 60 of the first and second spring mechanisms 32, 33 can be dedicated to either the first plurality of opposite compression plates 34, 36 or the second plurality of opposite compression plates 35, 37. For example, a spring element 60 can extend in a longitudinal direction parallel to the first or second directions F1, F2. Such a configuration can couple one of the first plurality of compression plates 34 to another of the first plurality of compression plates 36, or one of the second plurality of compression plates 35 to another of the second plurality of compression plates 37.

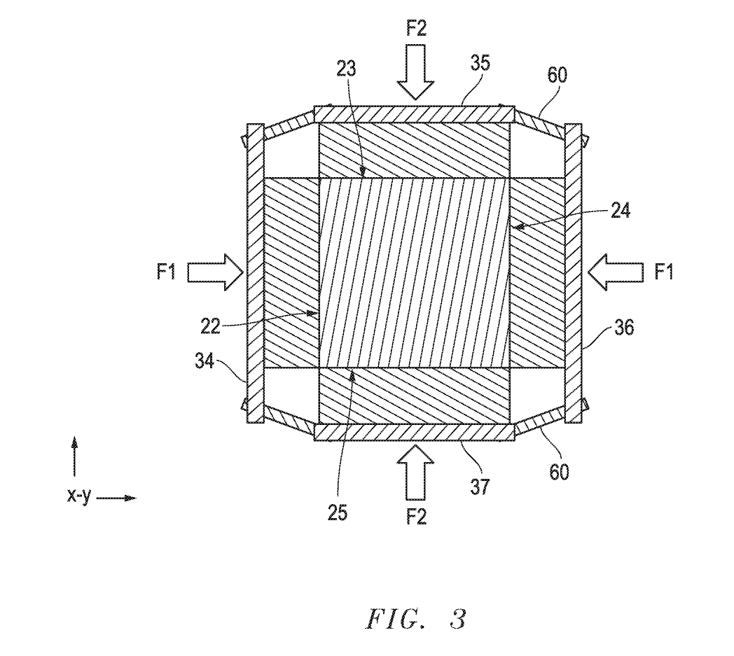

As illustrated in FIG. 3, the spring elements 60 and compression plates 34, 35, 36, 37 can be configured similar to the configuration illustrated in FIG. 1, except that the oblique angle of the spring elements 60 can be configured such that the spring mechanism 32 preferentially compresses in the first direction at the expense or reduction of the compression in the second direction, or vice versa. Such a configuration could be used when an increased compressive force is desired in one direction over the other.

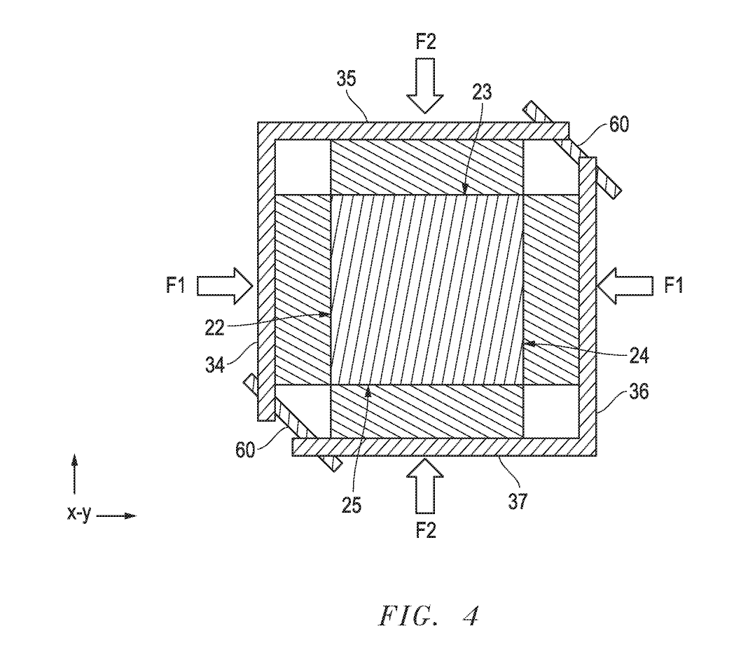

As illustrated in FIG. 4, the spring elements 60 and compression plates 34, 35, 36, 37 can be configured similar to the configuration illustrated in FIG. 1, except that the number of spring elements 60 and compression plates are reduced. For example, the spring mechanism can include a pair of spring elements 60 at opposing corners. Further, the compression plates 34 and 35 form a single monolithic compression plate and the compression plates 36 and 37 form a single monolithic compression plate, providing solid, non-elastic opposite corners.

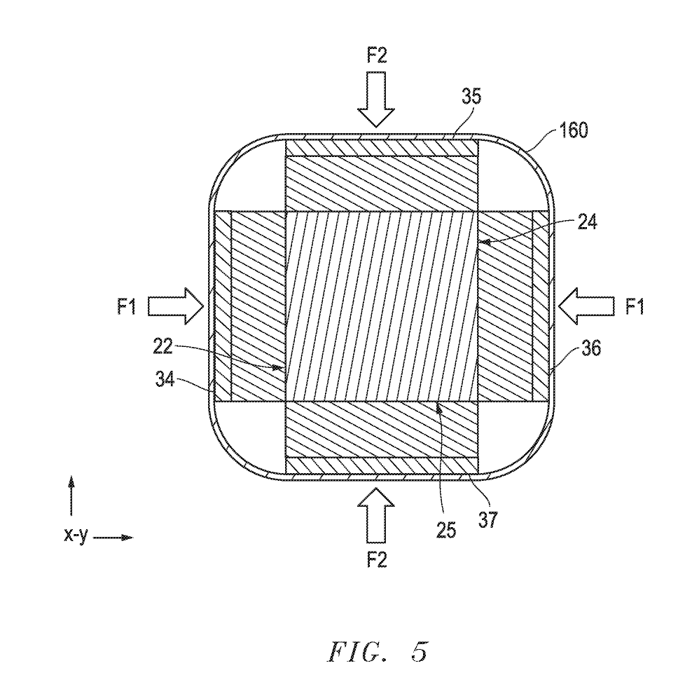

In further embodiments, as illustrated in FIG. 5, the compression device 60 can include a band 160 surrounding and biaxially compressing the high temperature device along the x-y plane instead of separate spring elements 60. For example, the compression device can include the first and second pluralities of compression plates 34, 36 and 35, 37 between the band 160 and the high temperature device 20 and the band can be tightened to exert the F1 and F2 compression forces along the first and second directions. In particular embodiments, the band 160 can include a metal, such as a metal band with a coefficient of thermal expansion that is less than or equal to the high temperature device 20. If the metal band has a coefficient of thermal expansion equal to the high temperature device and it is pre-tightened, as the high temperature device expands due to thermal expansion from room temperature to operating temperature, the metal band will apply a substantially consistent compression force throughout the temperature range. If the metal band has a coefficient of thermal expansion less than that of the high temperature device, as the high temperature device expands due to thermal expansion from room temperature to operating temperature, the metal band will apply an increasing compression force proportional to the difference of thermal expansion coefficients.

In a further embodiment, the compression device can include any one of the configurations in FIGS. 1 to 5, 7, and 11, arranged so as to exert force in the z-direction and a direction orthogonal to the z-direction, referred to above as vertical-horizontal compression. For example, as illustrated in FIG. 12, the vertical-horizontal compression device can include a first plurality of compression plates 34, 36 disposed along a horizontal axis (e.g., x or y axis) and a second plurality of compression plates 35, 37 along a vertical axis (e.g., z axis).

In an embodiment, the compression plates can be coupled to each other to exert a force in the vertical and horizontal directions. The compression plates can be coupled using a spring 60 or a band 160, as described above. In a particular embodiment, the compression plates can be coupled via springs 60 such that increasing the load on one axis can decrease the load on the other axis.

In an embodiment, the vertical-horizontal compression device can be disposed on a high temperature device, such as a planar solid oxide fuel cell. The planar solid oxide fuel cell can be configured in a stack, where planar cells are separated by planar electrical interconnect components that conduct electricity between the cells. A current collector can be disposed on the stack to facilitate current collection. In a particular embodiment, a current collector can be disposed between the stack and a compression plate. For example, as illustrated in FIG. 12, a current collector 95 can be disposed on opposing ends of the stack and between opposing compression plates. In a particular embodiment, the current collectors and the corresponding compression plates can be disposed along the vertical axis of the vertical-horizontal compression device.

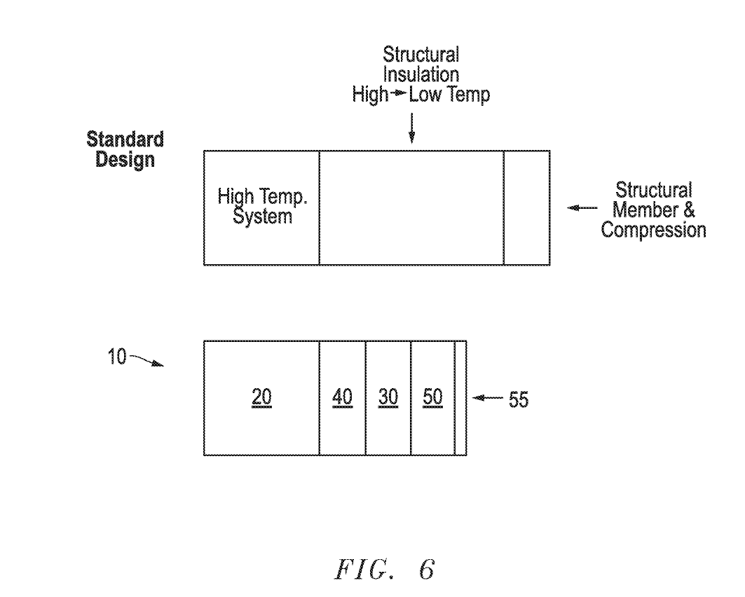

Further, certain embodiments of the high temperature system 10 described herein can allow for the use of conventional, low temperature, high strength materials at an intermediate temperature by decoupling the thermal and mechanical requirements of the insulation. Separating the insulation into high temperature and low temperature insulations can reduce bulkiness and provide a more compact and efficient structure. As illustrated in FIG. 6, in a standard cold compression design, a thick structural insulation of relatively high thermal conductivity must be used in order to transmit load from the outer structural member while sufficiently reducing to ambient temperature. As a result, the thickness and weight of the insulation can be bulky and heavy, and the outer structural member must in turn also be larger and heavier to support it. By contrast, in certain embodiments described herein, the thickness of structural, high temperature insulation 40 can be reduced while still allowing for use of low temperature, high strength materials for the compression device 30, and outside of the compression device, a non-structural, low temperature insulation 50 can be used to reduce to ambient temperature. Thus, by comparison to existing external compression systems, embodiments described herein can be lighter, thinner, or both. For example, as illustrated in FIG. 6, the high temperature system 10 can include a high temperature insulation 40 and a low temperature insulation 50 separated by the compression device 30. Further, the low temperature insulation can be encapsulated by a non-structural outermost skin 55.

In certain embodiments, the high temperature insulation 40 can be disposed between the spring compression device 30 and the high temperature device 20. In certain embodiments, the high temperature insulation 40 can be adapted to withstand a high operating temperature, exhibit a high compressive strength, and reduce the external temperature from a high temperature to an intermediate temperature such that a conventional low temperature, high strength material can be used to generate and transmit a compressive load.

As discussed above, the high temperature insulation 40 can be adapted to reduce a temperature from a high operating temperature to an intermediate temperature. In certain embodiments, the high operating temperature can be in a range of from about 500° C. to about 1000° C., or about 700° C. to about 900° C. In further embodiments, the intermediate temperature can be in a range of from about 400° C. to about 600° C., such as less than 500° C., or no greater than the higher end of the temperature range of the low temperature, high strength material of the compression device 30.

In certain embodiments, the high temperature insulation can have a thermal conductivity TC_{H} at 800° C. of at least 90, at least 95, or even at least 100 mW/m*K. In further embodiments, the high temperature insulation may have a thermal conductivity TC_{H} at 800° C. of no greater than 500, no greater than 400, or even no greater than 350 mW/m*K. Moreover, the high temperature insulation can have a thermal conductivity TC_{H} at 800° C. in a range of any of the above minimum and maximum values, such as in a range of 90 to 500, 95 to 400, or even 100 to 350 mW/m*K. The thermal conductivity can be measured according to the axial heat flow method (ASTM E1225-13).

In certain embodiments, the high temperature insulation 40 can be a structural insulation having a high compression strength and a high density. In particular embodiments, the high temperature insulation 40 can have a compression strength (or cold crush strength) at 20° C. of at least 0.02, or at least 0.025, or at least 0.03 MPa. In further embodiments, the high temperature insulation 40 may have a compression strength at 20° C. of no greater than 8, no greater than 6.5, or no greater than 5 MPa. Moreover, the high temperature insulation 40 can have a compression strength at 20° C. in a range of any of the above maximum and minimum values, such as in a range of 0.02 to 8, 0.025 to 6.5, or 0.03 to 5 MPa. The compression strength can be measured according to standard EN ISO 8895:2004 (Heat-insulating shaped refractory).

In certain embodiments, the high temperature insulation 40 can have a density at 20° C. of at least 0.2, at least 0.23, or at least 0.25 g/cm³. In further embodiments, the high temperature insulation 40 may have a density at 20° C. of no greater than 9, no greater than 8, or no greater than 7.5 g/cm³. Moreover, the high temperature insulation 40 can have a density at 20° C. in a range of any of the above minimum and maximum values, such as in a range of 0.2 to 9, 0.23 to 8, or 0.25 to 7.5 g/cm³. The density can be measured according to Archimedes' Principle.

In certain embodiments, the high temperature insulation 40 can include a ceramic material, such as a ceramic material comprising an alumina. In particular embodiments, the high temperature insulation 40 can include the insulation materials listed in Table 1 below.

TABLE 1

| | Thermal | Compressive | |
|---|---|---|---|
| | Conductivity | Strength | Density |
| | @ 800° C. | @ 20° C. | @ 20° C. |
| | W/m*K | kPa | g/cm³ |
| ZIRCAR | 0.31 | 1310 | 0.48 |
| SALI | | | |
| Norfoam A | 0.47 | 1000 | 0.5 |
| d.05 | | | |
| Norfoam A | 0.60 | 4500 | 0.7 |
| d0.7 TSR | | | |
| Silcapor Ultra | 0.044 | 417 | 0.2-0.25 |
| 950 | | | |

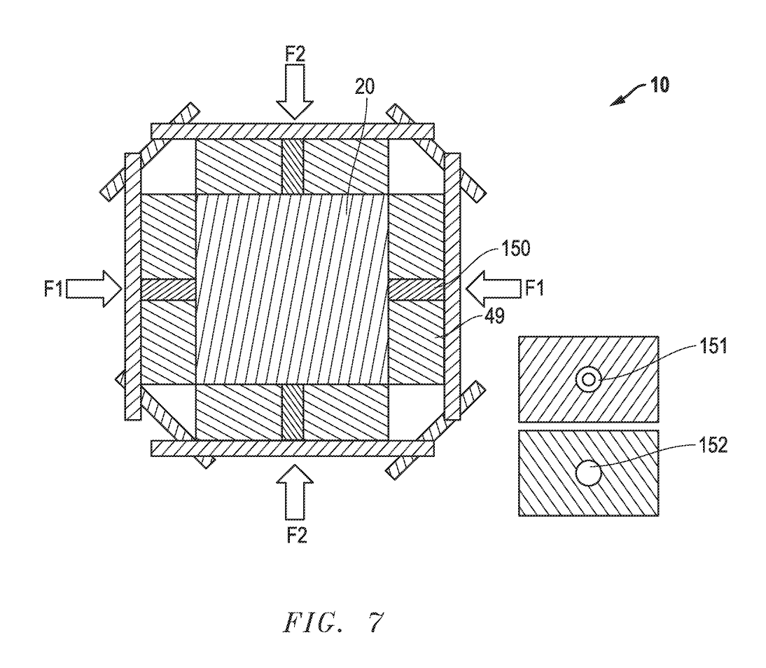

Further, as illustrated in FIG. 7, the high temperature insulation 49 can include a non-structural insulation, such as a pourable or powder insulation. The non-structural insulation can include, for example, a granulated MICROTHERM FREE FLOW microporous insulation (available from Microtherm at Maryville, Tenn., USA), a MICROSIL microporous insulation (available from Zircar at Florida, N.Y., USA), or an IB-100A or B alumina bubble insulation (available from Zircar at Florida, N.Y., USA). To add structural support, the high temperature system can include a high strength, conducting or non-insulating, structural member 150 covering a portion of the contact area against the high temperature device 20 and directly transmitting force from the compression device 30 to the high temperature device 20.

In further embodiments, the low temperature insulation 50 can be disposed external to the compression device 30 such that the compression device 30 is disposed between the high temperature insulation 40 and the low temperature insulation 50. In certain embodiments, the low temperature insulation 50 can be adapted to surround the compression device 30 and reduce the external temperature to an ambient temperature. In particular embodiments, the low temperature insulation 50 can be a non-structural insulation, for example, providing little or no mechanical strength.

The low temperature insulation 50 can be disposed external to the compression device 30. The low temperature insulation can be adapted to have a low thermal conductivity TC_{L} and a low density. In certain embodiments, the low temperature insulation has a thermal conductivity TC_{L} at 500° C. of at least 15, at least 17, or at least 20 mW/m*K. In further embodiments, the low temperature insulation may have a thermal conductivity TC_{L} at 500° C. of no greater than 400, no greater than 300, or no greater than 250 mW/m*K. Moreover, in certain embodiments, the low temperature insulation may have a thermal conductivity TC_{L} at 500° C. in a range of any of the above minimum and maximum values, such as in a range of 50 to 400, 55 to 300, or 60 to 250 mW/m*K. In very particular embodiments, the low temperature insulation can have a thermal conductivity TC_{L} at 500° C. in a range of 20 to 250 mW/m*K.

In certain embodiments, the low temperature insulation comprises a non-structural insulation having a low density, to provide a less bulky, more compact design. In other embodiments, the low temperature insulation can be a structural insulation. In particular embodiments, the low temperature insulation may have a density at 20° C. of no greater than 1, no greater than 0.7, or no greater than 0.5 g/cm³. In more particular embodiments, the low temperature insulation can have a density at 20° C. of at least 0.05, at least 0.07, or at least 0.1 g/cm³. Moreover, in certain embodiments, the low temperature insulation can have a density at 20° C. in a range of 0.05 to 1, 0.07 to 0.7, or 0.1 to 0.5 g/cm³.

In particular embodiments, the low temperature insulation can comprise an aerogel, a carbon nanofoam, an alumina fiberboard, an encapsulated cavity, an air gap, or any combination thereof. A non-limiting list of examples of the low temperature insulation are provided below in Table 2.

TABLE 2

| | Thermal | Compressive | |
|---|---|---|---|
| | Conductivity | Strength | Density |
| | @ 500° C. | @ 20° C. | @ 20° C. |
| | W/m*K | kPa | g/cm³ |
| Zircar | 0.029 | 0.0011 | 0.23 |
| Microsil | | | |
| Air (no | 0.058 | N/A | 0.00044 |
| convection) | | | |
| Pyrogel XT-E | 0.064 | 78 | 0.20 |
| Carbon | 0.089 | — | 0.25 |
| Nanofoam | | | |
| ZIRCAR | 0.110 | 100 | 0.32 |
| Type ASH | | | |

The high temperature and low temperature insulation can work in concert to provide sufficient temperatures to use conventional metals while reducing bulk. In certain embodiments, the ratio of TC_{H}:TC_{L} is in a range of 1 to 11, where TC_{H} is a thermal conductivity of the high temperature insulation and TC_{L} is a thermal conductivity of the low temperature insulation.

FIGS. 8 and 9 include a perspective view of other embodiments of the system described herein. As discussed above, the high temperature device can include a fluid inlet and a fluid outlet and the system can include a fluid inlet conduit and a fluid outlet conduit extending through the compression device, through the high temperature insulation, through the low temperature insulation, or a combination thereof. The fluid inlet conduit and the fluid outlet conduit can comprise metal tubing. The fluid outlet includes an air outlet 71 and a fuel outlet 72, and the fluid inlet includes an air inlet and a fuel inlet (not pictured) opposite the air and fuel inlets.

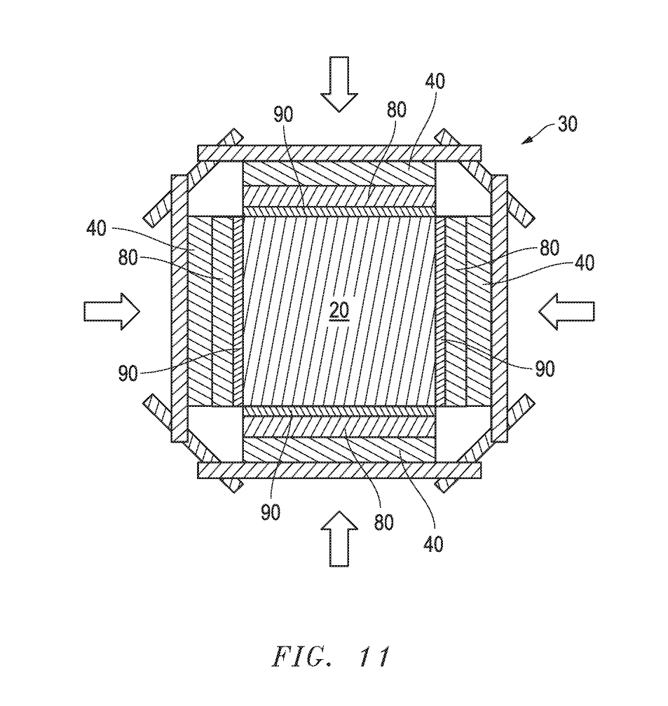

FIG. 8 includes an illustration of a high temperature electrochemical system surrounded by structural insulation, and compressed by diagonal springs via metal compression plates. FIG. 9 includes an illustration of a high temperature electrochemical system with gas tubes in and out of the four flow faces. In the case that the high temperature system is a cross flow SOFC stack, metal tubes comprised of ZMG 232 G10 (available from Hitachi Metals America, LLC at Arlington Heights, Ill., USA), CROFER 22APU or CROFER 22H (available from VDM Metals at Werdohl, Germany) to supply exhaust gas and air to/from all four faces. Furthermore, the compression device 30 can be used to compress high temperature gaskets comprised of phlogopite mica, vermiculite, or Thermiculite 866 or Thermiculite 866 LS (available from Flexitallic, LP at Deer Park, Tex., USA) in order to prevent fuel or air leakage from the outlets or inlets. Using the SOFC system in FIG. 9, flow-through data comparing the outflow in the two different crossflow directions to the inflow, shown as a percentage of the inflow is provided in FIG. 10. The data in FIG. 10 reveals that the compression device applies and maintains sufficient compression such that flow through for both the air and gas streams in a solid oxide fuel cell stack above 90% before, during, and after a 600° C. test.

An advantage of certain embodiments described herein is that the electrochemical system can have an improved volumetric power density and in improved power/kg. In certain embodiments, the electrochemical system can have a volumetric power density of at least 58,000 W/m³, at least 70,000 W/m³, or even at least 90,000 W/m3. The volume can be measured via Archimedes' Principle. For an electrochemical device, power is measured by a current voltage curve under electrical load at given operating conditions. The volumetric power density is thus the ratio of the operating power divided by the displaced volume. Further, the electrochemical system can have a power-to-weight ratio (power/kg) of at least 18 W/kg. Weight, or more correctly, mass is measured using a standard scale. The power-to-weight ratio is thus the ratio of the operating power divided by the mass of the high temperature device.

Also described herein is a method of compressing an electrochemical device. In certain embodiments, the method can comprise providing the electrochemical device; providing a layer of high temperature insulation adjacent the electrochemical device; and biaxially compressing the layer of high temperature insulation against the electrochemical device. Biaxially compressing the layer of high temperature insulation can include providing the compression device previously described herein. The method can further include providing a layer of low temperature insulation external to the compression device and the layer of high temperature insulation, low temperature insulation, or both, can include the low temperature insulation, high temperature insulation, or both, previously described herein. Further, the electrochemical device can include the electrochemical device previously described herein.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the embodiments as listed below.

### Embodiment 1

A high temperature system comprising:
   a high temperature device having a sidewall defining a first plurality of opposite surfaces and a second plurality of opposite surfaces;
   a compression device external to the sidewall of the high temperature device, the compression device adapted to exert a biaxial compression against the first and second opposite surfaces via material elasticity.

### Embodiment 2

The high temperature system of embodiment 1, further comprising:
   a high temperature insulation disposed between the compression device and the high temperature device; and
   a low temperature insulation disposed external to the compression device such that the compression device is disposed between the high temperature insulation and the low temperature insulation.

### Embodiment 3

A high temperature system comprising:
   a high temperature device having a sidewall defining an outer surface of the device;
   a compression device external to the sidewall of the high temperature device;
   a high temperature insulation disposed between the compression device and the high temperature device; and
   a low temperature insulation disposed external to the compression device such that the compression device is disposed between the high temperature insulation and the low temperature insulation.

### Embodiment 4

The high temperature system of embodiment 3, wherein
   the sidewall defines a first plurality of opposite surfaces and a second plurality of opposite surfaces; and
   the compression device is adapted to exert a biaxial compression against the first and second opposite surfaces via material elasticity.

### Embodiment 5

A method of compressing a high temperature device, the method comprising:
   providing the high temperature device;
   providing a layer of high temperature insulation adjacent to the high temperature device;
   providing a compression device external to the layer of high temperature insulation; and
   biaxially compressing the layer of high temperature insulation against the high temperature device in a first direction and a second direction, the first and second directions lying along an x-y plane, a z-x plane, or a z-y plane, relative to the high temperature device.

### Embodiment 6

The method of embodiment 5, further comprising providing a low temperature insulation external to the compression device such that the compression device is disposed between the high temperature insulation and the low temperature insulation.

### Embodiment 7

The method of any one of embodiments 5 and 6, wherein the compression device exerts the biaxial compression against first and second opposite surfaces of the high temperature device via material elasticity.

### Embodiment 8

The high temperature system or method of any one of the preceding embodiments, wherein the high temperature device has an operating temperature of at least 500° C.

### Embodiment 9

The high temperature system or method of any one of the preceding embodiments, wherein the high temperature device further comprises a fluid inlet, a fluid outlet, or both.

### Embodiment 10

The high temperature system or method of any of the preceding embodiments, wherein the high temperature device includes a fuel reformer, a heat exchanger, a filter, a reactor, or an electrochemical device.

### Embodiment 11

The high temperature system or method of any one of the preceding embodiments, wherein the high temperature device includes an electrochemical device.

### Embodiment 12

The high temperature system or method of embodiment 11, wherein the electrochemical device comprises a battery.

### Embodiment 13

The high temperature system or method of embodiment 11, wherein the electrochemical device comprises a fuel cell.

### Embodiment 14

The high temperature system or method of embodiment 13, wherein the electrochemical device comprises a solid oxide fuel cell stack.

### Embodiment 15

The high temperature system or method of any one of embodiments 13 and 14, wherein the electrochemical device comprises a monolithic solid oxide fuel cell stack.

### Embodiment 16

The high temperature system or method of any one of embodiments 13 to 15, wherein the electrochemical device comprises a cross-flow solid oxide fuel cell stack.

### Embodiment 17

The high temperature system or method of embodiment 16, wherein the electrochemical device includes a fluid inlet and a fluid outlet and the high temperature system includes a fluid inlet conduit and a fluid outlet conduit extending through the compression device, through the high temperature insulation, through the low temperature insulation, or a combination thereof.

### Embodiment 18

The high temperature system or method of embodiment 17, wherein the fluid inlet conduit and the fluid outlet conduit comprise metal tubing.

### Embodiment 19

The high temperature system or method of any one of embodiments 17 and 18, wherein the fluid inlet includes an air inlet and a fuel inlet, and the fluid outlet includes an air outlet and a fuel outlet.

### Embodiment 20

The high temperature system or method of any one of the preceding embodiments, the high temperature system further comprising a fluid delivery and distribution manifold disposed adjacent to the high temperature device, such as between the high temperature device and the compression device.

### Embodiment 21

The high temperature system or method of embodiment 20, wherein the fluid delivery and distribution manifold includes a cross-flow fluid delivery and distribution manifold such that fluids can flow crosswise relative to each other through the high temperature device.

### Embodiment 22

The high temperature system or method of any one of the embodiments 20 and 21, wherein the fluid delivery and distribution manifold includes a high temperature, non-yielding material adapted to maintain structural integrity at the operating temperature of the high temperature device.

### Embodiment 23

The high temperature system or method of embodiment 22, wherein the high temperature, non-yielding material includes a ceramic, such as a ceramic including an alumina, a stabilized zirconia, an MgO doped MgAl₂O₄ spinel, or any combination thereof.

### Embodiment 24

The high temperature system or method of any one of embodiments 20-23, the high temperature system further comprising a seal disposed between the fluid delivery and distribution manifold and the high temperature device.

### Embodiment 25

The high temperature system or method of embodiment 24, wherein the seal is adapted to maintain an essentially leak-free seal.

### Embodiment 26

The high temperature system or method of any one of embodiments 24 and 25, wherein the seal includes a compressible gasket.

### Embodiment 27

The high temperature system or method of embodiment 26, wherein the compressible gasket comprises a phlogophite mica, a muscovite mica, a vermiculite, or any combination thereof.

### Embodiment 28

The high temperature system or method of embodiment 27, wherein the vermiculite includes a chemically exfoliated vermiculite.

### Embodiment 29

The high temperature system or method of any one of embodiments 24 and 25, wherein the seal includes a non-compressible gasket.

### Embodiment 30

The high temperature system or method of embodiment 29, wherein the non-compressible gasket comprises a viscous glass, a glass ceramic, or a combination thereof.

### Embodiment 31

The high temperature system or method of any one of embodiments 1, 2, and 4 to 30, wherein the biaxial compression includes a first uniaxial compression force in a first direction and a second uniaxial compression force in a second direction.

### Embodiment 32

The high temperature system or method of embodiment 31, wherein first direction and the second direction both lie along an x-y plane relative to the high temperature device.

### Embodiment 33

The high temperature system or method of any one of embodiments 31 and 32, wherein the first direction intersects the second direction.

### Embodiment 34

The high temperature system or method of any one of embodiments 31 to 33, wherein first direction is orthogonal to the second direction.

### Embodiment 35

The high temperature system or method of any one of embodiments 31 to 34, wherein the high temperature device includes a third plurality of opposite surfaces having an intersecting axis orthogonal to the first and second directions, wherein the compression device does not exert a compression force on the third opposite surfaces.

### Embodiment 36

The high temperature system or method of any one of embodiments 31 to 35, wherein the high temperature device includes a third plurality of opposite surfaces having an intersecting axis orthogonal to the first and second directions, wherein the compression device is adapted to exert a compression force on the third opposite surfaces.

### Embodiment 37

The high temperature system or method of any one of the preceding embodiments, wherein the compression device includes a metal band with a coefficient of thermal expansion (CTE) that is not greater than the CTE of the high temperature device.

### Embodiment 38

The high temperature system of any one of embodiments 1 to 36, wherein the compression device includes a spring compression device.

### Embodiment 39

The high temperature system or method of embodiment 38, wherein the spring compression device comprises a spring mechanism adapted to exert a first compression force along a first direction intersecting the first plurality of opposite surfaces and to exert a second compression force along a second direction intersecting the second plurality of opposite surfaces.

### Embodiment 40

The high temperature system or method of embodiment 39, wherein the spring compression device comprising:
   a first plurality of opposite compression plates corresponding to the first plurality of opposite surfaces of the high temperature device; and
   a second plurality of opposite compression plates corresponding to the plurality of second opposite surfaces,
   wherein at least one compression plate per each of the first and second plurality of opposite compression plates adapted to be activated by the spring mechanism.

### Embodiment 41

The high temperature system or method of any one of embodiments 39 and 40, wherein the spring mechanism includes a first and second spring element adapted to activate the at least one compression plate per each of the first and second plurality of opposite compression plates.

### Embodiment 42

The high temperature system or method of embodiment 41, wherein each of the first and second spring elements extend in a longitudinal direction oblique to the first and second directions such that the direction of the vector sum of forces per compression plate is in the first or second directions.

### Embodiment 43

The high temperature system or method of embodiment 42, wherein each of the first and second spring elements is dedicated to both the first plurality of opposite compression plates and the second plurality of opposite compression plates.

### Embodiment 44

The high temperature system or method of any one of embodiments 42 and 43, wherein the oblique angle of the spring elements intentionally and preferentially compresses in either the first or second direction at the expense of the other of the first or second directions.

### Embodiment 45

The high temperature system or method of embodiment 41, wherein the first spring element is dedicated to the first plurality of opposite compression plates and the second spring element is dedicated to the second plurality of opposite compression plates.

### Embodiment 46

The high temperature system or method of embodiment 45, wherein the first and second spring elements extend in a longitudinal direction parallel to the first and second directions, respectively.

### Embodiment 47

The high temperature system or method of any one of embodiments 41 to 46, wherein the spring elements comprise compression springs, extension springs, or both.

### Embodiment 48

The high temperature system or method of any one of the preceding embodiments, wherein at least a portion of the compression device comprises a metal.

### Embodiment 49

The high temperature system or method of any one of embodiments 41 to 48, wherein spring elements of the spring compression device comprise a metal.

### Embodiment 50

The high temperature system or method of embodiment 49, wherein spring elements of the spring compression device comprise a metal including a nickel-iron alloy, a nickel-chromium alloy, or any combination thereof.

### Embodiment 51

The high temperature system of any one of embodiments 40 to 50, wherein compression plates of the spring compression device comprise a metal.

### Embodiment 52

The high temperature system or method of embodiment 51, wherein compression plates of the spring compression device comprise a stainless steel alloy, a nickel-chromium alloy, or any combination thereof.

### Embodiment 53

The high temperature system of any one of embodiments 2 to 52, wherein the high temperature insulation has a thermal conductivity TCH in a range of 100 to 350 mW/m*K.

### Embodiment 54

The high temperature system or method of any one of embodiments 2 to 53, wherein the high temperature insulation comprises a structural insulation having a cold crush strength of at least 1 MPa.

### Embodiment 55

The high temperature system or method of any one of embodiments 2 to 54, wherein the high temperature insulation has a density at 20° C. of at least 0.2, or at least 0.23, or at least 0.25 g/cm³.

### Embodiment 56

The high temperature system or method of any one of embodiments 2 to 53, wherein the high temperature insulation includes a non-structural insulation.

### Embodiment 57

The high temperature system or method of embodiment 56, wherein the high temperature system further comprises a high strength, non-insulating or conducting, structural member of low contact area that directly transmits force from the compression device to the high temperature device, and a remaining contact area includes the non-structural high temperature insulation.

### Embodiment 58

The high temperature system or method of any one of embodiments 2 to 57, wherein the high temperature insulation comprises a ceramic.

### Embodiment 59

The high temperature system of any one of embodiments 2 to 58, wherein the high temperature insulation comprises a ceramic including an alumina.

### Embodiment 60

The high temperature system or method of any one of embodiments 2, 3, and 6 to 59, wherein the low temperature insulation has a thermal conductivity TCL in a range of 20 to 250 mW/m*K.

### Embodiment 61

The high temperature system or method of any one of embodiments 2, 3, and 6 to 60, wherein the low temperature insulation comprises a non-structural insulation having a cold crush strength or no greater than 1 MPa.

### Embodiment 62

The high temperature system or method of any one of embodiments 2, 3, and 6 to 61, wherein the low temperature insulation has a density of no greater than 0.5 g/cm3.

### Embodiment 63

The high temperature system or method of any one of embodiments 2, 3, and 6 to 62, wherein the low temperature insulation comprises an aerogel, a carbon nanofoam, an alumina fiberboard, an alumina fiber blanket, microporous silica, an encapsulated cavity, an air gap, or any combination thereof.

### Embodiment 64

The high temperature system or method of any one of embodiments 2, 3, and 6 to 63, further comprising a non-structural outermost skin encapsulating the low temperature insulation.

### Embodiment 65

The high temperature system or method of any one of embodiments 2, 3, and 6 to 64, wherein a ratio of TCH:TCL is in a range of 1 to 11, where TCH is a thermal conductivity of the high temperature insulation and TCL is a thermal conductivity of the low temperature insulation.

### Embodiment 66

The high temperature system or method of any one of the preceding embodiments, wherein the high temperature system has a volumetric power density of at least 58,000 W/m3.

### Embodiment 67

The high temperature system or method of any one of the preceding embodiments, wherein the electrochemical system has a power/kg of at least 18 W/kg.

### Embodiment 68

The high temperature system or method of any one of the preceding claims, wherein the biaxial compression includes a horizontal-horizontal compression.

### Embodiment 69

The high temperature system or method of any one of the preceding embodiments, wherein the biaxial compression includes a vertical-horizontal compression.

### Embodiment 70

The high temperature system of any of the preceding embodiments, wherein the compression device includes a load spreading device that transfers a compressive force of the biaxial compression onto the high temperature insulation such that the stress on the high temperature insulation is less than the cold crush strength of the high temperature insulation.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range.

Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1.-15. (canceled)

16. A high temperature system comprising:
a high temperature device having a sidewall defining a first plurality of opposite surfaces and a second plurality of opposite surfaces;
a compression device external to the sidewall of the high temperature device, the compression device adapted to exert a biaxial compression against the first and second plurality of opposite surfaces via material elasticity.

17. The high temperature system of claim 16, further comprising:
a high temperature insulation disposed between the compression device and the high temperature device; and
a low temperature insulation disposed external to the compression device such that the compression device is disposed between the high temperature insulation and the low temperature insulation.

18. The high temperature system of claim 16, wherein the high temperature device has an operating temperature of at least 500° C.

19. The high temperature system of claim 16, wherein the high temperature device includes a fuel reformer, a heat exchanger, a filter, a reactor, or an electrochemical device.

20. The high temperature system of claim 16, wherein the high temperature device includes a cross-flow solid oxide fuel cell stack.

21. The high temperature system of claim 16, wherein the high temperature system further comprises a manifold disposed between the high temperature device and the compression device.

22. The high temperature system of claim 16, wherein the biaxial compression includes a first uniaxial compression force in a first direction and a second uniaxial compression force in a second direction.

23. The high temperature system of claim 22, wherein the high temperature device includes a third plurality of opposite surfaces having an intersecting axis orthogonal to the first and second directions, wherein the compression device is adapted to exert a compression force on the third plurality of opposite surfaces in a direction orthogonal to the biaxial compression.

25. The high temperature system of claim 16, wherein the compression device includes a metal band with a coefficient of thermal expansion (CTE) that is not greater than a CTE of the high temperature device.

26. The high temperature system of claim 16, wherein the compression device includes a spring compression device including a spring mechanism adapted to exert a first compression force along a first direction intersecting the first plurality of opposite surfaces and to exert a second compression force along a second direction intersecting the second plurality of opposite surfaces.

27. A high temperature system comprising:
a high temperature device having a sidewall defining an outer surface of the device;
a compression device external to the sidewall of the high temperature device;
a high temperature insulation disposed between the compression device and the high temperature device; and
a low temperature insulation disposed external to the compression device such that the compression device is disposed between the high temperature insulation and the low temperature insulation.

28. The high temperature system of claim 27, wherein the sidewall defines a first plurality of opposite surfaces and a second plurality of opposite surfaces; and the compression device is adapted to exert a biaxial compression against the first and second plurality of opposite surfaces via material elasticity.

29. The high temperature system of claim 28, wherein the compression device includes a spring compression device comprising:
a first plurality of opposite compression plates corresponding to a first plurality of opposite surfaces of the high temperature device; and
a second plurality of opposite compression plates corresponding to a second plurality of opposite surfaces of the high temperature device,
wherein at least one compression plate per each of the first and second plurality of opposite compression plates is adapted to be activated by a spring mechanism adapted to exert a first compression force along a first direction intersecting the first plurality of opposite surfaces and to exert a second compression force along a second direction intersecting the second plurality of opposite surfaces.

30. The high temperature system of claim 29, wherein the spring mechanism includes a first and second spring element adapted to activate the at least one compression plate per each of the first and second plurality of opposite compression plates, and each of the first and second spring elements extend in a longitudinal direction oblique to the first and second directions such that a direction of a vector sum of forces per compression plate is in the first or second directions.

31. The high temperature system of claim 30, wherein each of the first and second spring elements is dedicated to both the first plurality of opposite compression plates and the second plurality of opposite compression plates.

32. The high temperature system of claim 30, wherein the first spring element is dedicated to the first plurality of opposite compression plates and the second spring element is dedicated to the second plurality of opposite compression plates.

33. The high temperature system of claim 29, wherein the spring compression device comprises a metal including a nickel-iron alloy, a nickel-chromium alloy, or any combination thereof.

34. The high temperature system of claim 28, wherein the low temperature insulation has a thermal conductivity TC_{L} lower than a thermal conductivity TC_{H} of the high temperature insulation.

35. The high temperature system of claim 28, wherein the compression device includes a load spreading device that transfers a compressive force of biaxial compression onto the high temperature insulation such that stress on the high temperature insulation is less than cold crush strength of the high temperature insulation.
